(19) United States
(12) Patent Application Publication
(10) Pub. No.: US 2008/0298650 A1
(43) Pub. Date: Dec. 4, 2008

(54) Optical finger print acquisition apparatus using a prism

(76) Inventors: Dong Hyuk Jang, Seoul (KR); Kum Yong Hwang, Incheon (KR); Seok Joon Yoon, Yongin-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,055

(22) Filed: Jul. 12, 2007

(30) Foreign Application Priority Data
Jun. 4, 2007 (KR) 10-2007-0054456

(51) Int. Cl. G06K 9/00

(52) U.S. Cl. 382/127

(57) ABSTRACT

An optical fingerprint acquisition apparatus using a prism, which can improve the quality of a fingerprint image acquired by an image sensor, is provided. The optical fingerprint acquisition apparatus using the prism includes a pentagon prism including an input face 11 which receives a beam, a first support face 12 which is extended from one end of the input face 11, a contact face 13 which is obliquely extended from one end of the first support face 12 at a first tilt angle a1 and is horizontal to the input face 11, a second support face 14 which is extended from one end of the contact face 13, and an output face 15 which is vertically extended from one end of the second support face 14 and extended from another end of the input face 11, wherein, when the beam illuminated to the input face 11 is illuminated to the contact face 13 with which a finger F contacts, the beam is scattered in ridges F1 of fingerprint and is reflected in valleys F2 of fingerprint and thereby illuminated to the output face 15, a light source 20, an imaging lens 30, and an image sensing unit 60 including a lens unit 40 which is provided to receive the beam illuminated to the imaging lens 30 so as to correct a distortion of the beam and prevent an undesired beam, and a sensor unit 50 which includes an image sensor 53 to receive the illuminated beam and thereby acquire a fingerprint image at a second tilt angle a2.

### BACKGROUND

1. Field

The present invention relates to an optical fingerprint acquisition apparatus using a prism, and more particularly, to an optical fingerprint acquisition apparatus using a prism, which can improve the quality of a fingerprint image acquired by an image sensor.

2. Background

As shown in FIG. 1, an optical fingerprint acquisition apparatus using a prism includes a prism 1, a light source 2, an imaging lens 3, and an image sensor 4. In this instance, the prism 1 includes an input face 1a, an output face 1b, and a contact face 1c forming an oblique side. The input face 1a and the output face 1b contacts with each other to form a right angle. The light source 2 is provided on the input face 1a of the prism 1, the imaging lens 3 and the image sensor 4 are provided on the output face 1b, and a finger F from which a fingerprint is acquired contacts with the contact face 1c. When the finger F contacts with the contact face 1c, a beam is generated from the light source 2 and illuminated to the input face 1a of the prism 1 and then is illuminated to the contact face 1c.

When the beam illuminated to the contact face 1c is illuminated to ridges of fingerprint F1, the illuminated beam is scattered as shown in a reference numeral “a1” of FIG. 1. The scattered beam gets out through the contact face 1c into the air and, in the case of a black and white fingerprint image, the fingerprint shows up in black. The beam illuminated to valleys of fingerprint F2 is totally reflected as shown in a reference numeral “a2” of FIG. 1. The totally reflected beam is illuminated to the output face 1b, and in the case of a black and white fingerprint image, the fingerprint shows up in white.

The totally reflected beam in the contact face 1c where the valleys of fingerprint F2 are located is illuminated to the imaging lens 3. The beam illuminated to the imaging lens 3 is illuminated to the image sensor 4. In this instance, the image sensor 4 converts the illuminated beam into an electrical signal and thereby acquires the fingerprint image. When the image sensor 4 acquires the fingerprint image, the acquired fingerprint image is registered or compared with other registered fingerprint images.

In the case of the optical fingerprint acquisition apparatus using the prism to acquire a fingerprint from a finger according to the conventional art, when an undesired beam from an outside is included in beams illuminated to the image sensor, the quality of the fingerprint image may be deteriorated.

### SUMMARY OF THE INVENTION

Therefore, the present invention is conceived to solve the above-described problems in the conventional art, and thus the present invention provides an optical fingerprint acquisition apparatus using a prism, which can eliminate an undesired beam from an outside and thereby improve a fingerprint image acquired by an image sensor, when the undesired beam is included in beams illuminated to the image sensor.

The present invention also provides an optical fingerprint acquisition apparatus using a prism, which can more readily install an image sensor at tilt.

To accomplish the above-described objectives, according to an aspect of the present invention, there is provided an optical fingerprint acquisition apparatus using a prism, the apparatus including: a pentagon prism including an input face which receives a beam, a first support face which is extended from one end of the input face, a contact face which is obliquely extended from one end of the first support face at a first tilt angle and is horizontal to the input face, a second support face which is extended from one end of the contact face, and an output face which is vertically extended from one end of the second support face and extended from another end of the input face, wherein, when the beam illuminated to the input face is illuminated to the contact face with which a finger contacts, the beam is scattered in ridges of fingerprint and is reflected in valleys of fingerprint and thereby illuminated to the output face; a light source being installed in the input face of the pentagon prism to generate the beam and illuminate the generated beam to the input face; an imaging lens being installed on the output face of the pentagon prism to receive the beam illuminated from the output face; and an image sensing unit including a lens unit which is provided to receive the beam illuminated to the imaging lens, and sequentially includes a first meniscus lens, a second meniscus lens, a third meniscus lens, and a biconvex lens so as to correct a distortion of the beam and prevent an undesired beam, and a sensor unit which includes an image sensor to receive the beam illuminated from the biconvex lens and acquire a fingerprint image wherein the image sensor is obliquely provided at a second tilt angle, wherein the size of the second tilt angle is in inverse proportion to the size of the first tilt angle.

### BRIEF DESCRIPTION OF THE DRAWINGS

The embodiments will be described in detail with reference to the following drawings in which like reference numerals refer to like elements wherein:

FIG. 1 is a cross-sectional view illustrating an optical fingerprint acquisition apparatus using a prism according to a conventional art;

FIG. 2 is a cross-sectional view illustrating an optical fingerprint acquisition apparatus using a prism according to an exemplary embodiment of the present invention;

FIG. 3 is a perspective view illustrating the prism shown in FIG. 2;

FIG. 4 is a cross-sectional view illustrating another embodiment of a light source shown in FIG. 2;

FIGS. 5A through 5D illustrate fingerprints corrected by lenses shown in FIG. 2; and

FIG. 6 is a cross-sectional view illustrating an optical fingerprint acquisition apparatus using a prism according to another exemplary embodiment of the present invention.

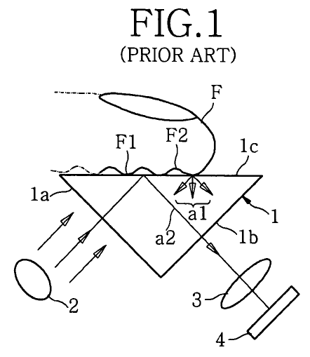

### DETAILED DESCRIPTION

Hereinafter, exemplary embodiments of the present invention will be described in detail with reference to the accompanying drawings.

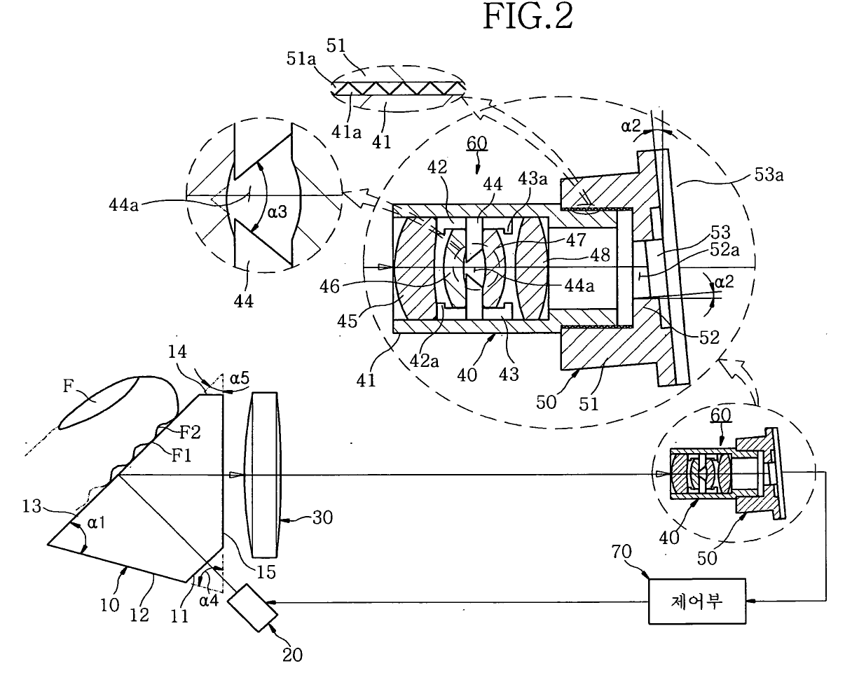

FIG. 2 is a cross-sectional view illustrating an optical fingerprint acquisition apparatus using a prism according to an exemplary embodiment of the present invention. As shown in FIG. 2, the optical fingerprint acquisition apparatus using the prism includes a pentagon prism 10, a light source 20, an imaging lens 30, and an image sensing unit 60. Hereinafter, configurations thereof will be sequentially described in detail.

The pentagon prism 10 includes an input face 11, a first support face 12, a contact face 13, a second support face 14, and an output face 15, so that, when a beam illuminated to the input face 11 is illuminated to the contact face 13 contacting with a finger F, the illuminated beam is scattered in ridges of fingerprint F1 and is reflected in valleys of fingerprint F2 and thereby is illuminated to the output face 15. Hereinafter, the relations thereof will be described.

The input face 11 receives a beam which is generated from the light source 20, and the first support face 12 is extended from one end of the input face 11. The contact face 13 is obliquely extended from one end of the first support face 12 at a first tilt angle a1 and horizontal to the input face 11. The second support face 14 is extended from one end of the contact face 13, and the output face 15 is vertically extended from one end of the second support face and also extended from another end of the input face 11.

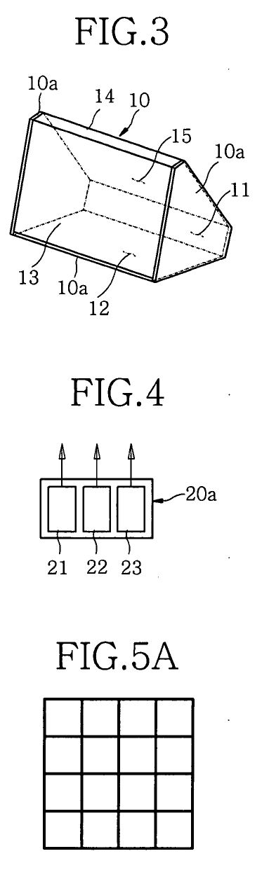

As shown in FIG. 3, the pentagon prism 10 includes a back matt paint layer 10a on each of both sides (no reference numeral mentioned) and the first support face 12 in order to make the background in black when a fingerprint is acquired. Also, the pentagon prism 10 forms the second face 14 with the input face 11 by cutting a corner portion which is formed at an angle a4 or a5 in a conventional triangle prism (no reference numeral mentioned). Since the pentagon prism 10 forms the second face 14 with the input face 11 by cutting the corner portion of the triangle prism, the pentagon prism 10 is formed to have each of both side faces in the shape of a pentagon. Accordingly, the pentagon prism 10 may be more readily installed in comparison with the conventional triangle prism due to the corners.

The light source 20 is installed in the input face 11 of the pentagon prism 10, generates a beam and illuminates the generated beam to the input face 11. The light source 20, which generates and illuminates the beam, is provided in a lower portion of the input face 11 which is obliquely extended from at another end of the output face 15 as shown in FIG. 2, generates the beam and illuminates the generated beam to the input face 11.

The imaging lens 30 is installed on the output face 15 of the pentagon prism 10 and receives the beam illuminated from the output face 15. The imaging lens 30, receives the illuminated beam, is installed on one side of the output face 15 which is vertically extended from one end of the second support face 14 of the pentagon prism 10 as shown in FIG. 2, and receives the beam illuminated from the output face 15.

As shown in FIG. 2, the image sensing unit 60 includes a lens unit 40 and a sensor unit 50. In this instance, the lens unit 40 is provided to receive the beam illuminated to the imaging lens 30, and sequentially includes a first meniscus lens 45, a second meniscus lens 46, a third meniscus lens 47, and a biconvex lens 48 so as to correct a distortion of the beam and prevent an undesired beam. Also, the sensor unit 50 includes an image sensor 53, obliquely provided at a second angle a2, to receive the beam illuminated from the biconvex lens 48 and acquire a fingerprint image.

Hereinafter, the lens unit 40 and the sensor unit 50 of the imaging sensor unit 60 will be further described in detail with reference to FIG. 2.

The lens unit 40 includes a first housing 41, a first support member 42, a second member 43, a diaphragm member 44, and a plurality of lenses 45, 46, 47, and 48. Hereinafter, configurations thereof will be described.

The first housing 41 is formed with a first screw thread 41a in an inner surface of another end of the first housing 41. The first support member 42 is installed in the first housing 41 and integrally formed with a first protruded member 42a on one end of the first support member 42. The second support member 43 is installed in the first housing 41 and integrally formed with a second protruded member 43a on another end of the second support member 43 to be located in another side of the first support member 42. The diaphragm member 44 is provided between the first support member 42 and the second support member 43, and includes a diaphragm 44a on a center tilted at a third tilt angle a3. In this instance, the diaphragm 44a is formed to have the third tilt angle of 70° to 120°, preferably, the diaphragm 44a may be formed to have the third tilt angle of 90° in order to more readily sharpen one end of the diaphragm 44a, and thereby prevent the undesired beam from the outside.

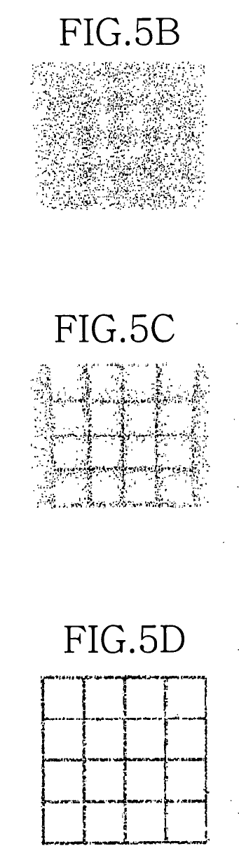

Among the plurality of lenses 45 through 48, the first meniscus lens 45 is installed in the first housing 41. When a lattice-pattern image, as shown in FIG. 5A, is illuminated from the imaging lens 30, the first meniscus lens 45 illuminates the lattice-pattern image to the second meniscus lens 46 in an indistinct lattice pattern image state. In this instance, the second meniscus lens 46 is installed in the first support member 42 to be surrounded by the first protruded member 42a. Also, the third meniscus lens 47 is installed in the second support member 43 to be surrounded by the second protruded member 43a and thus corrects an image, as shown in FIG. 5B, into an image state as shown in FIG. 5C.

The image shown in FIG. 5C is clearer than the image shown in FIG. 5B, however, still indistinct in comparison to the lattice pattern image shown in FIG. 5A. That is, a distortion or an indistinct portion is shown in an outline portion. Such image is illuminated from the third meniscus lens 47 to the biconvex lens 48. The biconvex lens 48 is installed in the first housing 41 to be located in another side of the second support member 43 and thereby corrects the distortion of the image shown in FIG. 5C into an image shown in FIG. 5D. The image shown in FIG. 5D is acquired when a beam, which can be illuminated from the outside, is blocked by the diaphragm 44a. In this instance, the plurality of lenses 45 through 48 constitutes a double gauss lens based on the diaphragm 44a. The lattice pattern images shown in FIGS. 5A through 5D indicate a portion where the ridges F1 of the finger F contacts with the contact face 13 of the pentagon prism 10, that is, indicates an image which is acquired by applying an object in the shape of a lattice pattern, instead of the finger F, to the optical fingerprint acquisition apparatus using the prism according to the present invention.

The sensor unit 50 includes a second housing 51, an installation member 52, and an image sensor 53. Hereinafter, configurations thereof will be described.

The second housing 51 is formed with a second screw thread 51a in an inner surface of the second housing 51 to be combined with the first screw thread 41a when the second housing 51 is combined with the first housing 41. The installation member 52 is integrally formed with the second housing 51 inside thereof, and includes a hole 52a which is obliquely formed in a center at the second tilt angle a2. The image sensor 53 is obliquely inserted into the hole. In this instance, the image sensor 53 is obliquely inserted into the hole at the second tilt angle a2 to thereby have the second tilt angle a2 based on a vertical direction. A charge coupled device (CCD) sensor is used for the image sensor 53, and a printed circuit board 53 mounted with the image sensor 53 is installed to contact with another end of the second housing 51.

The size of the second tilt angle a2 corresponding to an installation angle of the image sensor 53 is set to be in inverse proportion to the size of the first tilt angle a1 between the first support face 12 and the contact face 13. For example, when the first tilt angle a1 is within the range of 40° to 70°, the second tilt angle of the image sensor 53 is set to be within the range of 8.25° to 4.4°. Specifically, when the first tilt angle a1 is 40°, the second tilt angle a2 is set to 8.85°. Also, when the first tilt angle a2 is 60°, the second tilt angle a2 is set to 5.25°. Also, when the first tilt angle a1 is 70°, the second tilt angle a2 is set to 4.4. Accordingly, the image sensor 53 is tilted towards the vertical direction. By tilting the image sensor 53, it is possible to correct the distortion by a path length of the beam in a state where the contact face 13 of the pentagon prism 10 is obliquely installed.

When acquiring a fingerprint image by applying the optical fingerprint acquisition apparatus using the prism according to the present invention, which can correct the distortion of the fingerprint image by the ridges F1 and the values F2 of the fingerprint F contacting with the contact face 13 of the pentagon prism 10, in the case of a dry type or a wet type of the finger F, it is possible to apply the mono chromatic light source 20 and a multi-chromatic light source 20a, shown in FIG. 4, in order to more clearly acquire the fingerprint image.

As shown in FIG. 4, the multi-chromatic light source 20a includes a red light source 21, a green light source 22, and a blue light source 23, of which on/off is controlled by the control unit 70. When the finger F contacts with the contact face 13 of the pentagon prism 10, the control unit 70 drives the multi-chromatic light source 20a and thereby controls the fingerprint image to be acquired by the image sensing unit 60. Also, the control unit 70 determines which type the fingerprint image is among a normal type, a wet type, or the dry type, and adjusts the brightness of the beam generated from the multi-chromatic light source 20a.

When the fingerprint image is the normal type, the control unit 70 switches on the red light source 21 of the multi-chromatic light source 20a. When the finger F is the wet type, the control unit 70 switches on any one between the green light source 22 and the blue light source 23. Conversely, when the finger F is the dry type, the control unit 70 switches on the red light source 21 and the blue light source 23, or switches on all of the red light source 21, the green light source 22, and the blue light source 23. Through the above operations, the fingerprint of the finger F contacting with the contact face 13 is acquired.

For example, when the brightness of the beam is based on a grey scale level of 0 to 255, and the finger F is the normal type, the control unit 70 switches on the red light source 21 in order to adjust the brightness of the beam generated from the multi-chromatic light source 20a to the range of 80° to 120° . When the finger F is a little wet type, the control unit 70 switches on the green light source 22 in order to adjust the brightness of the beam to range of 120° to 140°. Also, when the finger F is a very wet type, the control unit 70 switches on the blue light source 23 in order to adjust the brightness of the beam to greater than or equal to 140°. Conversely, when the finger F is a little dry type, the control unit 70 switches on all of the red light source 21, the green light source 22, and the blue light source 23 in order to adjust the brightness of the beam to less than 60°. Also, when the finger F is a very dry type, the control unit 70 switches on the red light source 21 and the blue light source 23 in order to adjust the brightness of the beam to the range of 60° to 80°. Accordingly, even when the finger F is the dry type or the wet type, it is possible to accurately acquire the fingerprint image.

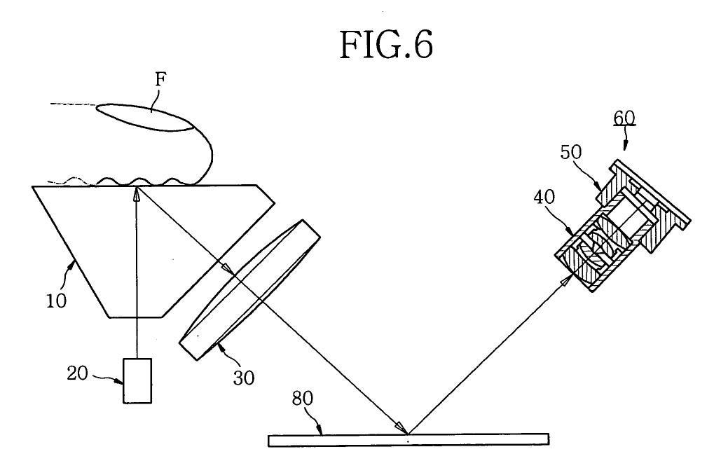

Also, a reflecting mirror 80 is further provided to apply the multi-chromatic light source 20a based on the dry type or the wet type of the finger F, and to compactly construct the fingerprint acquisition apparatus as shown in FIG. 6. As shown in FIG. 6, the reflecting mirror 80 is provided between the imaging lens 30 and the image sensing unit 60 and thereby reflects the beam illuminated from the imaging lens 30 to the imaging sensing unit 60 and a reflective face of the reflecting mirror 80 is formed of an aluminum material.

As described above, an optical fingerprint acquisition apparatus using a prism according to the present invention may eliminate an undesired beam from an outside using a diaphragm and thereby improve the quality of a fingerprint image acquired by an image sensor, when the undesired beam is included in beams illuminated to the image sensor. Also, when tilting the image sensor, the image sensor may be more readily installed by using a second housing.

What is claimed is:

1. An optical fingerprint acquisition apparatus using a prism, the apparatus comprising:
a pentagon prism comprising an input face which receives a beam, a first support face which is extended from one end of the input face, a contact face which is obliquely extended from one end of the first support face at a first tilt angle and is horizontal to the input face, a second support face which is extended from one end of the contact face, and an output face which is vertically extended from one end of the second support face and extended from another end of the input face, wherein, when the beam illuminated to the input face is illuminated to the contact face with which a finger contacts, the beam is scattered in ridges of fingerprint and is reflected in valleys of fingerprint and thereby illuminated to the output face;
a light source being installed in the input face of the pentagon prism to generate the beam and illuminate the generated beam to the input face;
an imaging lens being installed on the output face of the pentagon prism to receive the beam illuminated from the output face; and
an image sensing unit comprising a lens unit which is provided to receive the beam illuminated to the imaging lens, and sequentially includes a first meniscus lens, a second meniscus lens, a third meniscus lens, and a biconvex lens so as to correct a distortion of the beam and prevent an undesired beam, and a sensor unit which includes an image sensor to receive the beam illuminated from the biconvex lens and acquire a fingerprint image wherein the image sensor is obliquely provided at a second tilt angle,
wherein the size of the second tilt angle is in inverse proportion to the size of the first tilt angle.

2. The apparatus of claim 1, wherein the pentagon prism includes a back matt paint color on each of the first support face and both side faces to make a background in black when acquiring the fingerprint.

3. The apparatus of claim 1, wherein the light source includes any one between a mono chromatic light source and a multi-chromatic light source, and the multi-chromatic light source includes a red light source, a green light source, and a blue light source.

4. The apparatus of claim 1, wherein the image sensing unit comprises an image sensing unit comprising a lens unit which is provided to receive the beam illuminated to the imaging lens, and sequentially includes a first meniscus lens, a second meniscus lens, a third meniscus lens, and a biconvex lens so as to correct a distortion of the beam and prevent a undesired beam, and a sensor unit which includes an image sensor to receive the beam illuminated from the biconvex lens and acquire a fingerprint image wherein the image sensor is obliquely provided at a second tilt angle,
the lens unit comprises a first housing which is formed with a first screw thread in an inner surface of another end of the first housing, a first support member which is installed in the first housing and integrally formed with a first protruded member on one end of the first support member, a second support member which is installed in the first housing and integrally formed with a second protruded member on another end of the second support member to be located in another side of the first support member, a diaphragm member which is provided between the first support member and the second support member and includes a diaphragm on a center tilted at a third tilt angle, the first meniscus lens which is installed in the first housing to be located in one side of the first support member; the second meniscus lens which is installed in the first support member to be surrounded by the first protruded member, the third meniscus lens which is installed in the second support member to be surrounded by the second protruded member, and the biconvex lens which is installed in the first housing to be located in another side of the second support member, and the sensor unit comprises a second housing which is formed with a second screw thread in an inner surface of the second housing to be combined with the first screw thread when the second housing is combined with the first housing, an installation member which is integrally formed with the second housing inside thereof and includes a hole which is obliquely formed in a center at the second tilt angle, and the image sensor which is obliquely inserted into the hole at the second tilt angle.

5. The apparatus of claim 4, wherein the third tilt angle of the diaphragm is within the range of 70° to 120°.

6. The apparatus of claim 1, wherein, when the first tilt angle between the first support face and the contact face of the pentagon prism is within the range of 40° to 70°, the second tilt angle of the image sensor is set to be within the range of 8.25° to 4.4°.

7. The apparatus of claim 1, wherein a reflecting mirror is further provided between the imaging lens and the image sensing unit, and the reflecting mirror reflects the beam illuminated from the imaging lens to the image sensing unit, and a reflective face of the reflecting mirror is formed of an aluminum material.

8. An optical fingerprint acquisition apparatus using a prism, the apparatus comprising:
a pentagon prism comprising an input face which receives a beam, a first support face which is extended from one end of the input face, a contact face which obliquely extended from one end of the first support face at a first tilt angle and is horizontal to the input face, a second support face which is extended from one end of the contact face, and an output face which is vertically extended from one end of the second support face and extended from another end of the input face, wherein, when the beam illuminated to the input face is illuminated to the contact face with which a finger contacts, the beam is scattered in ridges of fingerprint and is reflected in valleys of fingerprint and thereby illuminated to the output face;
a multi-chromatic light source being provided to illuminate a generated beam to the input face of the pentagon prism, and comprising a recd light source, a green light source, and a blue light source;
an imaging lens being provided to receive the beam illuminated from the output face of the pentagon prism;
an image sensing unit comprising a lens unit which is provided to receive the beam illuminated to the imaging lens, and sequentially includes a first meniscus lens, a second meniscus lens, a third meniscus lens, and a biconvex lens so as to correct a distortion of the beam and prevent a undesired beam, and a sensor unit which includes an image sensor to receive the beam illuminated from the biconvex lens and acquire a fingerprint image wherein the image sensor is obliquely provided at a second tilt angle; and
a control unit driving the multi-chromatic light source when the finger contacts with the contact face of the pentagon prism, and thereby controlling the image sensing unit to acquire the fingerprint image,
wherein the size of the second tilt angle is set to be in inverse proportion to the size of the first tilt angle, and the control unit determines which type the acquired fingerprint image is among a normal type, a wet type, and a dry type, switches on the red light source of the multi-chromatic light source when the acquired fingerprint is the normal type, switches on any one between the green light source and the blue light source when the acquired fingerprint is the wet type, and switches on the red light source and the blue light source, or switches on all of the red light source, the green light source, and the blue light source when the acquired fingerprint image is the dry type, and thereby generates the beam.
